(19) United States
(12) Patent Application Publication
(10) Pub. No.: US 2025/0376031 A1
(43) Pub. Date: Dec. 11, 2025

(54) IN-VEHICLE TELLTALE FAILURE DIAGNOSIS DEVICE AND IN-VEHICLE TELLTALE FAILURE DIAGNOSIS METHOD

(71) Applicant: Nuvoton Technology Corporation Japan, Kyoto (JP)

(72) Inventors: Koichi FURUTANI, Osaka (JP); Masayasu MUKAI, Hyogo (JP)

(21) Appl. No.: 19/301,533

(22) Filed: Aug. 15, 2025

Related U.S. Application Data
(63) Continuation of application No. PCT/JP2024/004378, filed on Feb. 8, 2024.

(30) Foreign Application Priority Data
Mar. 1, 2023 (JP) 2023-031167

(51) Int. Cl. B60K 35/90; G06V 10/75

(52) U.S. Cl. CPC B60K 35/90; G06V 10/751; B60K 2360/119; B60K 2360/188

(57) ABSTRACT

An in-vehicle telltale failure diagnosis device includes: a correct-answer icon area memory controller that obtains and stores a reference correct-answer icon image; an icon image cutter that cuts out an icon image from a combined image; an icon correlation calculator that calculates a first correlation value between an icon in the icon image that has been cut out and an icon in the reference correct-answer icon image; a background correlation calculator that calculates a second correlation value between a background part excepting the icon and a predetermined tonal color; and an icon failure determiner that determines, based on the first correlation value, that the icon in the icon image is a failure, and a background failure determiner that determines, based on the second correlation value, that the background part in the icon image is a failure.

### CROSS REFERENCE TO RELATED APPLICATIONS

This is a continuation application of PCT International Patent Application No. PCT/JP2024/004378 filed on Feb. 8, 2024, designating the United States of America, which is based on and claims priority of Japanese Patent Application No. 2023-031167 filed on Mar. 1, 2023. The entire disclosures of the above-identified applications, including the specifications, drawings and claims are incorporated herein by reference in their entirety.

### FIELD

The present invention relates to in-vehicle telltale failure diagnosis devices and in-vehicle telltale failure diagnosis methods.

### BACKGROUND

Patent Literature (PTL) 1 discloses calculating a correlation value between (i) an icon image that is cut out from a combined image and serves as a telltale, and (ii) a reference correct-answer icon image that is read out from a storage means, and determining that the icon image is a failure. A correct-answer icon image is an icon image that serves as a reference, is stored in memory in advance, and is originally displayed in normal operation. PTL 2 discloses determining that an icon image is a failure by comparing an expected value and an arithmetic operation result for a cyclic redundancy check in a comparison controller that performs a cyclic redundancy check on any area in an icon image serving as a telltale. PTL 3, like PTL 2, recites “a vehicle” in the scope of the claims.

### CITATION LIST

### Patent Literature

PTL 1: Japanese Unexamined Patent Application Publication No. 2020-177058
PTL 2: Japanese Patent No. 5670117
PTL 3: Japanese Patent No. 5970055

### SUMMARY

### Technical Problem

The conventional techniques described in PTL 1, PTL 2, and PTL 3 enable determining that an icon image is a failure by taking a correlation between the icon image and a reference correct-answer icon image. However, when image quality degradation and a hue change occur in a current icon image to be processed, as affected by noise generated in image processing of, for instance, decompressing a compressed icon image, a case where the current icon image is different from an assumed reference correct-answer icon image may occur even when the current icon image is a normal icon image. Therefore, with these conventional techniques, false failure determination may occur.

The present disclosure provides an in-vehicle telltale failure diagnosis device and an in-vehicle telltale failure diagnosis method capable of inhibiting false failure determination in determining that an icon image serving as a telltale is a failure, even when image quality degradation and a hue change occur due to image processing.

### Solution to Problem

An in-vehicle telltale failure diagnosis device according to one aspect of the present disclosure diagnoses that an icon image generated by an in-vehicle image processing device is a failure, where the in-vehicle image processing device includes: a background image generator that generates a background image; an icon image generator that generates an icon image serving as a telltale; and an image combiner that generates a combined image by combining the generated icon image generated and the generated background image. The in-vehicle telltale failure diagnosis device includes: a correct-answer icon area memory controller that obtains and stores a reference correct-answer icon image; an icon image cutter that cuts out the icon image from the combined image output from the image combiner; an icon correlation calculator that calculates a first correlation value between an icon in the icon image that has been cut out by the icon image cutter and an icon in the reference correct-answer icon image stored in the correct-answer icon area memory controller; a background correlation calculator that calculates a second correlation value between a background part excepting the icon in the icon image that has been cut out and a predetermined tonal color; and an icon failure determiner that determines, based on the first correlation value calculated by the icon correlation calculator, that the icon in the icon image that has been cut out is a failure, and a background failure determiner that determines, based on the second correlation value calculated by the background correlation calculator, that the background part in the icon image that has been cut out is a failure.

An in-vehicle telltale failure diagnosis method according to one aspect of the present disclosure is an in-vehicle telltale failure diagnosis method of diagnosing that an icon image generated by an in-vehicle image processing device is a failure, where the in-vehicle image processing device includes: a background image generator that generates a background image; an icon image generator that generates an icon image serving as a telltale; and an image combiner that generates a combined image by combining the generated icon image and the generated background image. The in-vehicle telltale failure diagnosis method includes: obtaining and storing a reference correct-answer icon image; cutting out the icon image from the combined image output from the image combiner; calculating a first correlation value between an icon in the icon image that has been cut out in the cutting out of the icon image and an icon in the reference correct-answer icon image stored in the obtaining and storing of the reference correct-answer icon image; calculating a second correlation value between a background part excepting the icon in the icon image that has been cut out and a predetermined tonal color; and determining, based on the first correlation value calculated in the calculating of the first correlation value, that the icon in the icon image that has been cut out is a failure, and determining, based on the second correlation value calculated in the calculating of the second correlation value, that the background part in the icon image that has been cut out is a failure.

### Advantageous Effects

An in-vehicle telltale failure diagnosis device and an in-vehicle telltale failure diagnosis method according to one aspect of the present disclosure can inhibit false failure determination in determining that an icon image serving as a telltale is a failure, even when image quality degradation and a hue change occur due to image processing.

### BRIEF DESCRIPTION OF DRAWINGS

These and other advantages and features will become apparent from the following description thereof taken in conjunction with the accompanying Drawings, by way of non-limiting examples of embodiments disclosed herein.

FIG. 1 is a block diagram illustrating the configuration of an in-vehicle telltale failure diagnosis device according to a reference example.

FIG. 2A is a flowchart illustrating an operation of reading out a correct-answer icon image which is performed by the in-vehicle telltale failure diagnosis device according to the reference example.

FIG. 2B is a flowchart illustrating an operation of determining that an icon image is a failure which is performed by the in-vehicle telltale failure diagnosis device according to the reference example.

FIG. 3A is a conceptual diagram illustrating one example of a correct-answer icon image held in a correct-answer icon area memory controller, according to the reference example and an embodiment.

FIG. 3B is a conceptual diagram illustrating parameters placed in icon area memory, according to the reference example and the embodiment.

FIG. 4A is a conceptual diagram illustrating one example of a correct-answer icon image before image processing is performed on a character information image, according to the reference example and the embodiment.

FIG. 4B is a conceptual diagram illustrating mosquito noise generated due to quantization errors when image processing (image compression) is performed on a character information image, according to the reference example and the embodiment.

FIG. 4C is a conceptual diagram illustrating information indicating the difference between the correct-answer icon image in FIG. 4A and an image after image processing (image compression) in FIG. 4B, according to the reference example and the embodiment.

FIG. 4D is a diagram illustrating maximum values indicating a positive difference and a negative difference in each of the entirety, the icon area, and the background area in the 16×16 pixel block in FIG. 4C, according to the reference example and the embodiment.

FIG. 5 is a block diagram illustrating the configuration of an in-vehicle telltale failure diagnosis device according to the embodiment.

FIG. 6 is a flowchart illustrating an operation of determining that an icon is a failure and determining that a background is a failure, which is performed by the in-vehicle telltale failure diagnosis device according to the embodiment.

### DESCRIPTION OF EMBODIMENTS

In recent years, functional safety support for icon images serving as telltales and generated by an in-vehicle image processing device are becoming essential. This necessitates a mechanism for determining whether a generated icon image is a failure. However, when the in-vehicle image processing device performs image processing of, for instance, decompressing a compressed icon image, and image quality degradation and a hue change in the icon image occur as affected by noise generated in the image processing, a case where the decompressed normal icon image does not necessarily result in an assumed correct-answer icon image occurs and a conventional in-vehicle telltale failure diagnosis device may make false failure determination in determining that an icon image is a failure.

In view of this, an in-vehicle telltale failure diagnosis device according to Technique 1 of the present disclosure diagnoses that an icon image generated by an in-vehicle image processing device is a failure, where the in-vehicle image processing device includes: a background image generator that generates a background image; an icon image generator that generates an icon image serving as a telltale; and an image combiner that generates a combined image by combining the generated icon image generated and the generated background image. The in-vehicle telltale failure diagnosis device includes: a correct-answer icon area memory controller that obtains and stores a reference correct-answer icon image; an icon image cutter that cuts out the icon image from the combined image output from the image combiner; an icon correlation calculator that calculates a first correlation value between an icon in the icon image that has been cut out by the icon image cutter and an icon in the reference correct-answer icon image stored in the correct-answer icon area memory controller; a background correlation calculator that calculates a second correlation value between a background part excepting the icon in the icon image that has been cut out and a predetermined tonal color; and an icon failure determiner that determines, based on the first correlation value calculated by the icon correlation calculator, that the icon in the icon image that has been cut out is a failure, and a background failure determiner that determines, based on the second correlation value calculated by the background correlation calculator, that the background part in the icon image that has been cut out is a failure.

With this, the in-vehicle telltale failure diagnosis device determines that an icon image is a failure based on a correlation value obtained by independent calculation performed for the icon and the background part in the icon image, and calculates the correlation value by comparing a tonal color and the background part where image quality degradation and a hue change, as affected by noise generated in image processing, are likely to occur. Thus, the in-vehicle telltale failure diagnosis device is configured to readily adjust determination criteria for reducing an influence caused by noise. Accordingly, even when image quality degradation and a hue change occur in the current icon image due to image processing, the in-vehicle telltale failure diagnosis device can inhibit false failure determination that a current icon image to be processed is not an assumed correct-answer icon image.

For example, an in-vehicle telltale failure diagnosis device according to Technique 2 is the in-vehicle telltale failure diagnosis device according to Technique 1, and the reference correct-answer icon image includes the following as area information: an icon area; a background area; and an anti-aliasing area positioned at a boundary between the icon area and the background area. The icon correlation calculator calculates the first correlation value of the icon area in the reference correct-answer icon image. The background correlation calculator calculates the second correlation value of the background area in the reference correct-answer icon image.

With this, the in-vehicle telltale failure diagnosis device can readily identify the icon and the background part of a current icon image to be processed, by referencing the area information of a correct-answer icon image. Accordingly, the in-vehicle telltale failure diagnosis device can reduce a memory capacity and determine that the current icon image is a failure in a short time.

For example, an in-vehicle telltale failure diagnosis device according to Technique 3 is the in-vehicle telltale failure diagnosis device according to Technique 1 or 2, and the icon failure determiner (i) determines whether the first correlation value calculated on a pixel-by-pixel basis by the icon correlation calculator is within a first threshold value and correlation is low, (ii) further determines whether a total number of pixels for which the first correlation value is determined to be within the first threshold value is a first predetermined number or greater, and (iii) determines that the icon image is possibly a failure when determining that the total number of the pixels is the first predetermined number or greater. With this, when the number of pixels for which the first correlation value is determined to be within the first threshold value is the first predetermined number or greater and correlation is low, it is determined that the icon in the icon image is possibly a failure. This therefore results in adding filtering that allows a case where image quality degradation and a hue change occur in the current icon image due to image processing, and false failure determination is inhibited.

For example, an in-vehicle telltale failure diagnosis device according to Technique 4 is the in-vehicle telltale failure diagnosis device according to Technique 3, and the first threshold value is a variable value. With this, by adjusting the first threshold value, determination criteria for false failure determination for the icon in the icon image can be adjusted in accordance with the level of noise that may be generated in image processing.

For example, an in-vehicle telltale failure diagnosis device according to Technique 5 is the in-vehicle telltale failure diagnosis device according to Technique 1 or 2, and the background failure determiner (i) determines whether the second correlation value calculated on a pixel-by-pixel basis by the background correlation calculator is within a second threshold value and correlation is low, (ii) further determines whether a total number of pixels for which the second correlation value is determined to be within the second threshold value is a second predetermined number or greater, and (iii) determines that the icon image is possibly a failure when determining that the total number of the pixels is the second predetermined number or greater. With this, when the number of pixels for which the second correlation value is determined to be within the second threshold value and correlation is low, it is determined that the background part in the icon image is possibly a failure. This therefore results in adding filtering that allows a case where image quality degradation and a hue change occur in the current icon image due to image processing, and false failure determination is inhibited.

For example, an in-vehicle telltale failure diagnosis device according to Technique 6 is the in-vehicle telltale failure diagnosis device according to Technique 5, and the second threshold value is a variable value. With this, by adjusting the second threshold value, determination criteria for false failure determination for the background part in the icon image can be adjusted in accordance with the level of noise that may be generated in image processing.

For example, an in-vehicle telltale failure diagnosis device according to Technique 7 is the in-vehicle telltale failure diagnosis device according to Technique 3, and the combined image is a moving image. The icon failure determiner (i) determines, for each frame included in the combined image, whether a total number of pixels for which the first correlation value is determined to be within the first threshold value is the first predetermined number or greater, and (ii) determines that the icon image is a failure when frames in which the total number of the pixels is the first predetermined number or greater occur consecutively for a first predetermined number of frames. With this, it is determined that the icon in the icon image is a failure only when frames in which the total number of the pixels is the first predetermined number or greater occur consecutively for the first predetermined number of frames. Accordingly, this results in adding, for the icon in the icon image, second filtering that allows a case where image quality degradation and a hue change occur in the current icon image due to image processing, and false failure determination is surely inhibited.

For example, an in-vehicle telltale failure diagnosis device according to Technique 8 is the in-vehicle telltale failure diagnosis device according to Technique 7, and the first predetermined number of frames is a variable value. With this, by adjusting the first predetermined number of frames which serves as a threshold value, determination criteria for false failure determination for the icon in the icon image can be adjusted in accordance with the level of noise that may be generated in image processing.

For example, an in-vehicle telltale failure diagnosis device according to Technique 9 is the in-vehicle telltale failure diagnosis device according to Technique 5, and the combined image is a moving image. The background failure determiner (i) determines, for each frame included in the combined image, whether a total number of pixels for which the second correlation value is determined to be within the second threshold value is the second predetermined number or greater, and (ii) determines that the icon image is a failure when frames in which the total number of the pixels is the second predetermined number or greater occur consecutively for a second predetermined number of frames. With this, it is determined that the background part in the icon image is a failure only when frames in which the total number of the pixels is the second predetermined number or greater occur consecutively for the second predetermined number of frames. Accordingly, this results in adding, for the background part in the icon image, second filtering that allows a case where image quality degradation and a hue change occur in the current icon image due to image processing, and false failure determination is surely inhibited.

For example, an in-vehicle telltale failure diagnosis device according to Technique 10 is the in-vehicle telltale failure diagnosis device according to Technique 9, and the second predetermined number of frames is a variable value. With this, by adjusting the second predetermined number of frames which serves as a threshold value, determination criteria for false failure determination for the background part in the icon image can be adjusted in accordance with the level of noise that may be generated in image processing.

For example, an in-vehicle telltale failure diagnosis method according to Technique 11 is an in-vehicle telltale failure diagnosis method of diagnosing that an icon image generated by an in-vehicle image processing device is a failure, where the in-vehicle image processing device includes: a background image generator that generates a background image; an icon image generator that generates an icon image serving as a telltale; and an image combiner that generates a combined image by combining the generated icon image and the generated background image. The in-vehicle telltale failure diagnosis method includes: obtaining and storing a reference correct-answer icon image; cutting out the icon image from the combined image output from the image combiner; calculating a first correlation value between an icon in the icon image that has been cut out in the cutting out of the icon image and an icon in the reference correct-answer icon image stored in the obtaining and storing of the reference correct-answer icon image; calculating a second correlation value between a background part excepting the icon in the icon image that has been cut out and a predetermined tonal color; and determining, based on the first correlation value calculated in the calculating of the first correlation value, that the icon in the icon image that has been cut out is a failure, and determining, based on the second correlation value calculated in the calculating of the second correlation value, that the background part in the icon image that has been cut out is a failure.

With the in-vehicle telltale failure diagnosis method described above, that an icon image is a failure is determined based on a correlation value obtained by independent calculation performed for the icon and the background part in the icon image, and the correlation value is calculated by comparing a tonal color and the background part where image quality degradation and a hue change, as affected by noise generated in image processing, are likely to occur. Therefore, determination criteria for reducing an influence caused by noise are readily adjusted. Accordingly, even when image quality degradation and a hue change occur in the current icon image due to image processing, the in-vehicle telltale failure diagnosis method can inhibit false failure determination that a current icon image to be processed is not an assumed correct-answer icon image.

Hereinafter, with reference to the drawings, an in-vehicle telltale failure diagnosis device having a minimum configuration that can achieve an objective will be described as a reference example, and after that, an in-vehicle telltale failure diagnosis device that can achieve the objective more reliably will be described as an embodiment of the present disclosure. It should be noted that the reference example and the embodiment described below each show a general or specific example of the present disclosure. The numeric values, shapes, materials, elements, arrangement and connection of the elements, steps, and an order of steps, etc. indicated in the following reference example and embodiment are mere examples, and do not intend to limit the present disclosure.

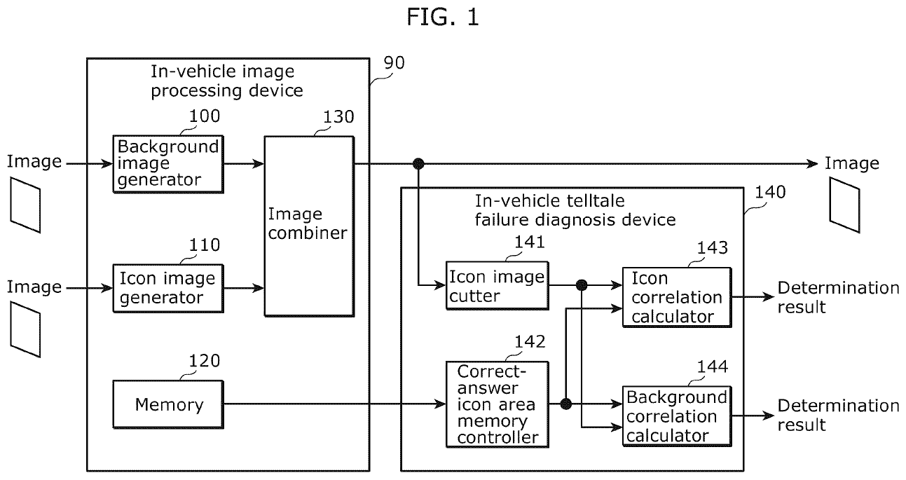

FIG. 1 is a block diagram illustrating the configuration of in-vehicle telltale failure diagnosis device 140 according to a reference example. In-vehicle image processing device 90 that generates a combined image including an icon image on which failure diagnosis is to be performed by in-vehicle telltale failure diagnosis device 140 is also illustrated in the figure.

In-vehicle image processing device 90 includes: background image generator 100 that generates a background image; icon image generator 110 that generates an icon image serving as a telltale; image combiner 130 that generates a combined image by combining the generated icon image and the generated background image; and memory 120 that holds a reference correct-answer icon image.

Background image generator 100 is, for instance, an in-vehicle camera that obtains a background image, and transmits the obtained background image on a line-by-line basis to image combiner 130. The image includes pixels. Each of the pixels composing the background image includes components such as RGB.

Icon image generator 110 generates an icon image serving as a telltale, and transmits the generated icon image on a line-by-line basis to image combiner 130. The icon image includes pixels. Each of the pixels composing the icon image includes components such as RGB.

Image combiner 130 superimposes a background image transmitted on a line-by-line basis from background image generator 100 onto an icon image transmitted on a line-by-line basis from icon image generator 110, to combine the background image and the icon image. Each of pixels composing a combined image includes components such as RGB. Image combiner 130 transmits the generated image on a line-by-line basis to, for instance, a display (not shown in the figure).

In the present embodiment, memory 120 holds, as a reference correct-answer icon image, area information and a correct-answer image of each area indicated by the area information. Area information is mapping data indicating three types of areas in an icon image, i.e., three types of areas that are an icon area, a background area, and an anti-aliasing area positioned at the boundary between the icon area and the background area. A correct-answer image of each of the areas of the three types is a set of pixels each including components such as RGB.

It should be noted that in the present specification, “an icon image” is composed by the image of an icon area (this image is simply referred to as “an icon”), the image of a background area (this image is simply referred to as “a background part”), and the image of an anti-aliasing area (this image is simply referred to as “an anti-aliasing part”). When all of pixels in the area of each of the correct-answer image of the icon and the correct-answer image of the background part have the same one color, each of the correct-answer image of the icon and the correct-answer image of the background part may be composed only by one color data that specifies that same one color.

In-vehicle telltale failure diagnosis device 140 receives, on a line-by-line basis, a combined image output from image combiner 130 in in-vehicle image processing device 90. The combined image includes pixels. Each of the pixels composing the combined image includes components such as RGB.

In-vehicle telltale failure diagnosis device 140 obtains only a necessary area when receiving a combined image on a line-by-line basis, and obtains only a 64×64 pixel block, for example. In-vehicle telltale failure diagnosis device 140 sends a failure determination result in accordance with icon correlation calculator 143 and background correlation calculator 144 based on an icon image cut out by icon image cutter 141.

Specifically, in-vehicle telltale failure diagnosis device 140 includes: icon image cutter 141 that cuts out an icon image from a combined image output from image combiner 130; correct-answer icon area memory controller 142 that obtains and stores a reference correct-answer icon image from memory 120; icon correlation calculator 143 that calculates a first correlation value between the icon in the icon image cut out by icon image cutter 141 and the icon in the reference correct-answer icon image stored by correct-answer icon area memory controller 142; and background correlation calculator 144 that calculates a second correlation value between the background part excepting the icon in the cut-out icon image and a predetermined tonal color. These elements are, for example, electric circuits. More specifically, these elements are implemented by, for instance, semiconductor logic circuits or a processor that performs processing in accordance with a program.

For each component included in a pixel in a combined image output from image combiner 130, icon image cutter 141 cuts out an icon image for data of the component in a pixel in a current block to be processed. Thus, pixels corresponding to the components corresponding to the current block are cut out. For example, a 64×64 pixel icon block is cut out as a current block to be processed, i.e., an icon image.

Correct-answer icon area memory controller 142 reads out, in synchronization with icon image cutter 141, a correct-answer icon image including area information stored in memory 120, holds the correct-answer icon image in internal memory, and notifies each of icon correlation calculator 143 and background correlation calculator 144 of information related to the icon area (information related to the icon area and the correct-answer image of the icon) and information related to the background area (information related to the background area and the correct-answer image of the background part) based on the correct-answer icon image including the area information.

This enables icon correlation calculator 143 to perform failure determination by obtaining information related to the icon area to calculate, in real time, a first correlation value for the icon included in a current block to be processed (i.e., a current icon image to be processed), and enables background correlation calculator 144 to perform failure determination by obtaining information related to the background area to calculate, in real time, a second correlation value for the background part included in the current block (i.e., the current icon image).

In other words, icon correlation calculator 143 calculates the first correlation value between the icon included in cut-out data of each component in the current block (i.e., the current icon image) and the icon in the correct-answer icon image. More specifically, icon correlation calculator 143 calculates the first correlation value between the correct-answer icon image and the current block regarding only the icon area notified from correct-answer icon area memory controller 142, and sends a determination result regarding the calculated first correlation value. The first correlation value may be calculated based on a difference per pixel between corresponding pixels in each component between the icon in the correct-answer icon image and the icon in the current block. A first correlation value indicates that the correlation between the icons is higher (the matching degree is higher) as the first correlation value increases. In addition, the determination may be whether the difference is a first threshold value or greater. The notification of the determination result may be made for each frame.

Background correlation calculator 144 calculates the second correlation value between the background part included in cut-out data of each component in the current block (i.e., the current icon image) and the background part in the correct-answer icon image. More specifically, background correlation calculator 144 calculates the second correlation value between the correct-answer icon image and the current block regarding only the background area notified from correct-answer icon area memory controller 142, and sends a determination result regarding the calculated second correlation value. The second correlation value may be calculated based on a difference in an average value in the background area between the background part included in the correct-answer icon image and the background part included in the current block, or based on a difference per pixel between corresponding pixels. A second correlation value indicates that the correlation between the background parts is higher (the matching degree is higher) as the second correlation value increases. In addition, the determination may be whether the difference is a second threshold value or greater. The notification of the determination result may be made for each frame.

With this, whether the current icon image is correct (i.e., whether the current icon image is not a failure) is determined in accordance with the correct-answer icon image.

It should be noted that a correct-answer image in a correct-answer icon image may have register set values that are set in advance by in-vehicle telltale failure diagnosis device 140 instead of values read out from memory 120 by correct-answer icon area memory controller 142. For example, if all of pixels of the correct-answer image of the icon are the same red pixels, a set value that R indicates 255, G indicates 0, and B indicates 0 may be held as the correct-answer image of the icon in the register of correct-answer icon area memory controller 142 or the register of icon correlation calculator 143, and used in the calculation of correlation values. Likewise, if all of pixels of the correct-answer image of the background part are the same black pixels, a set value that R indicates 0, G indicates 0, and B indicates 0 may be held as the correct-answer image of the background part in the register of correct-answer icon area memory controller 142 or the register of background correlation calculator 144. In such a variation, failure diagnosis is performed on data of each component in the current block in accordance with the correct-answer image of the icon and the correct-answer image of the background part held in, for instance, correct-answer icon area memory controller 142.

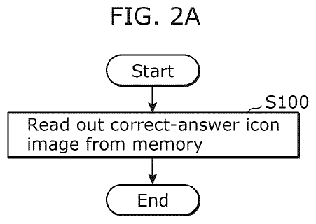

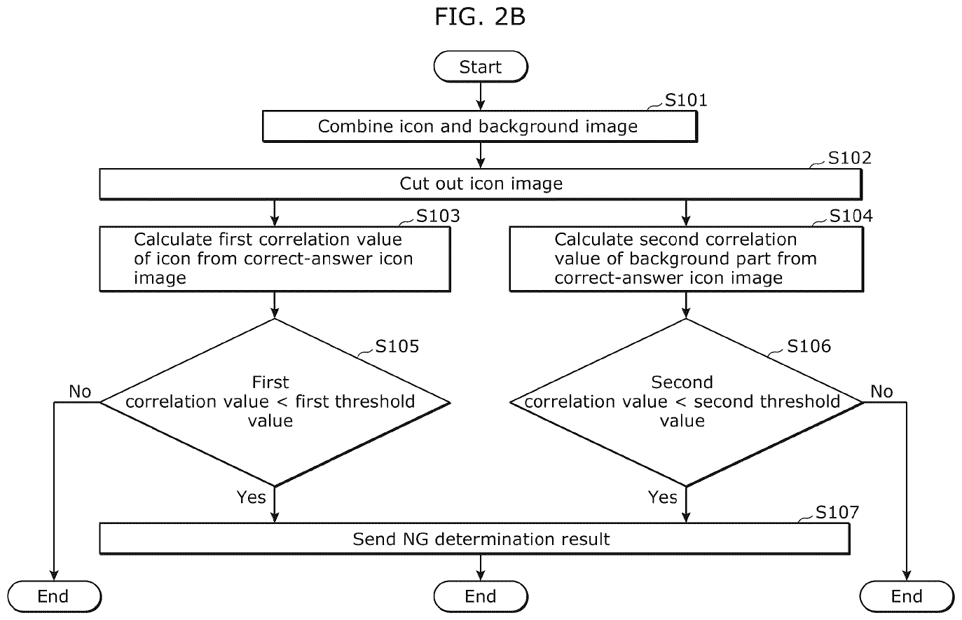

FIG. 2A is a flowchart illustrating an operation of reading out a correct-answer icon image which is performed by in-vehicle telltale failure diagnosis device 140 illustrated in FIG. 1. Since a process of writing a reference correct-answer icon image into memory 120 is performed as preprocessing, after this, correct-answer icon area memory controller 142 obtains and holds the reference correct-answer icon image from memory 120 (S100).

FIG. 2B is a flowchart illustrating an operation of determining that an icon image is a failure which is performed by in-vehicle telltale failure diagnosis device 140 illustrated in FIG. 1. First, an icon image and a background image are combined by image combiner 130 in in-vehicle image processing device 90 (S101). It should be noted that this combining process (S101) may or may not be performed to generate an input image to be input to in-vehicle telltale failure diagnosis device 140. After that, in in-vehicle telltale failure diagnosis device 140, icon image cutter 141 cuts out an icon image per any current block having 64×64 pixels from a combined image output from image combiner 130 (S102).

Based on information related to the icon area in the cut-out icon image and information related to the icon area in the correct-answer icon image notified from correct-answer icon area memory controller 142, icon correlation calculator 143 calculates, for each component, a first correlation value between the icon included in data of the component in the current block (i.e., the current icon image) and the icon in the correct-answer icon image (S103).

Also, based on information related to the background area in the cut-out icon image and information related to the background area in the correct-answer icon image notified from correct-answer icon area memory controller 142, background correlation calculator 144 calculates, for each component, a second correlation value between the background part included in data of the component in the current block (i.e., the current icon image) and the background part in the correct-answer icon image (S104).

When there is no difference, regarding each component, between the icon in the correct-answer icon image in the current block and the icon in the current icon image (i.e., the first correlation value is greater than the first threshold value and the correlation between the icons is high) (No in S105), icon correlation calculator 143 determines that the current icon image is not a failure, and ends the process performed on the current block. When there is a difference between the icon in the correct-answer icon image and the icon in the current icon image (i.e., the first correlation value is within the first threshold value and the correlation between the icons is low) (Yes in S105), icon correlation calculator 143 determines that the current icon image is a failure, and sends an NG determination result (S107).

Also, when there is no difference, regarding each component, between the background part in the correct-answer icon image in the current block and the background part in the current icon image (i.e., the second correlation value is greater than the second threshold value and the correlation between the background parts is high) (No in S106), background correlation calculator 144 determines that the current icon image is not a failure, and ends the process performed on the current block. When there is a difference between the background part in the correct-answer icon image and the background part in the current icon image (i.e., the second correlation value is within the second threshold value and the correlation between the background parts is low) (Yes in S106), background correlation calculator 144 determines that the current icon image is a failure, and sends an NG determination result (S107).

With this, it is detected that the icon and the background part of the current block have no anomaly in accordance with the correct-answer icon image. It should be noted that in-vehicle telltale failure diagnosis device 140 performs, for each of components included in a pixel, the calculation of the first correlation value (S103), the calculation of the second correlation value (S104), and the NG determination result notification (S107), for instance.

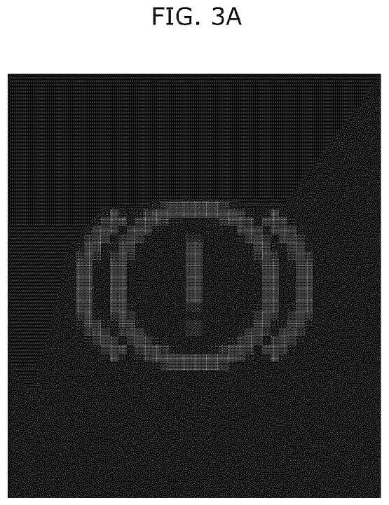

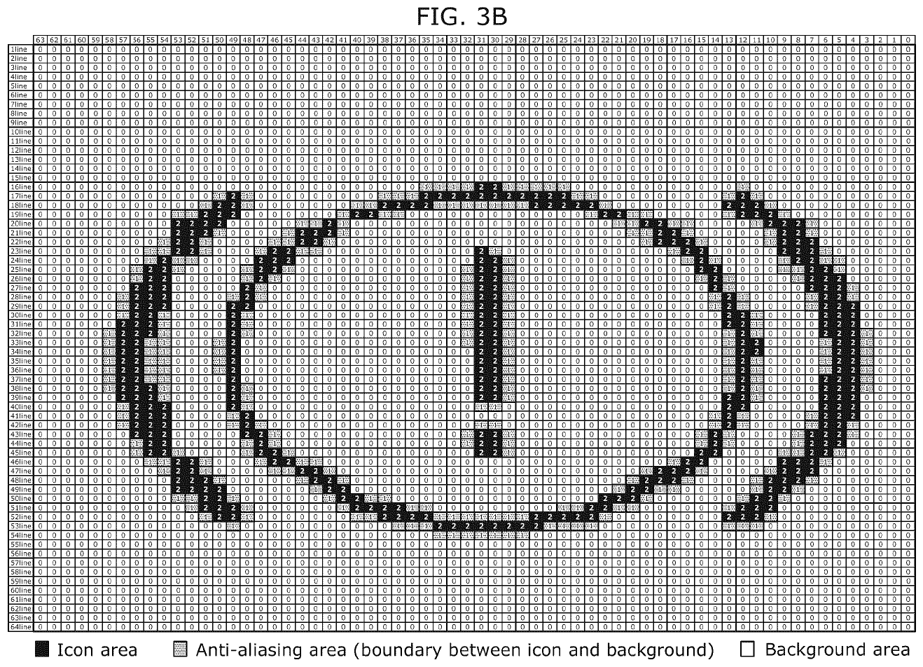

FIG. 3A is a diagram illustrating one example of a correct-answer icon image held in correct-answer icon area memory controller 142, according to the reference example and the embodiment to be described later. Correct-answer icon area memory controller 142 determines icon area memory for holding area information, based on the size of the correct-answer icon image (i.e., secures the icon area memory and be prepared). The block size of an icon area, which is specifically a block including 64×64 information items, is variable at discretion, and when there are a plurality of correct-answer icons to be displayed, icon areas can be determined for a required amount. In the icon area memory, parameters that distinguish three types of areas that are an icon area, a background area, and an anti-aliasing area are placed as area information, as illustrated in FIG. 3B. This enables the area determination of the three types by using, as area information of the correct-answer icon image, only 2 bits for distinguishing the three types and without using 8-bit information, and processing time and memory capacity are reduced. It should be noted that the correct-answer image of the icon area and the correct-answer image of the background area are held separately from the area information by correct-answer icon area memory controller 142 or by icon correlation calculator 143 and background correlation calculator 144.

FIG. 3B is a conceptual diagram illustrating parameters placed in the icon area memory based on the correct-answer icon image in FIG. 3A, according to the reference example and the embodiment to be described later. As illustrated in FIG. 3B, the icon area has 64×64 information items each indicating any one of the three types, and more specifically, the icon area has information indicating any one of the icon area, the background area, and the anti-aliasing area. Correct-answer icon area memory controller 142 references area information and notifies icon correlation calculator 143 of the icon area to cause icon correlation calculator 143 to check, for each component in the current block, whether there is a difference between the icon area in the correct-answer icon image and the icon area in the current icon image.

Moreover, correct-answer icon area memory controller 142 references area information and notifies background correlation calculator 144 of the background area to cause background correlation calculator 144 to check, for each component in the current block, whether there is a difference between the background area in the correct-answer icon image and the background area in the current icon image.

In the example illustrated in FIG. 3B, the area information specifically has 64×64 information items, but the size of the area information can be changed arbitrarily. Furthermore, when there is a plurality of correct-answer icon images, area information may be prepared for a required amount.

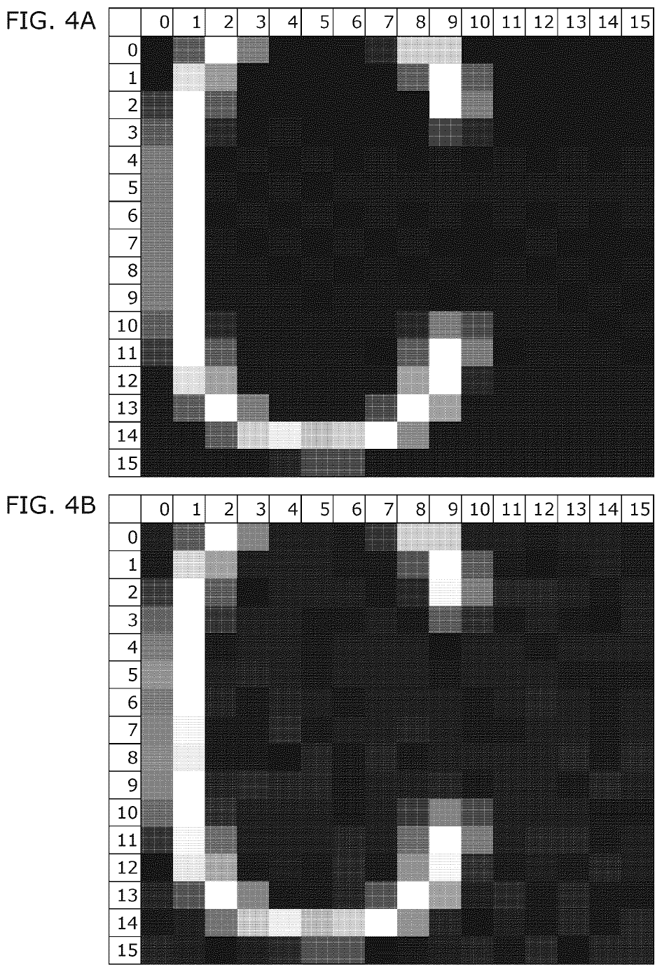

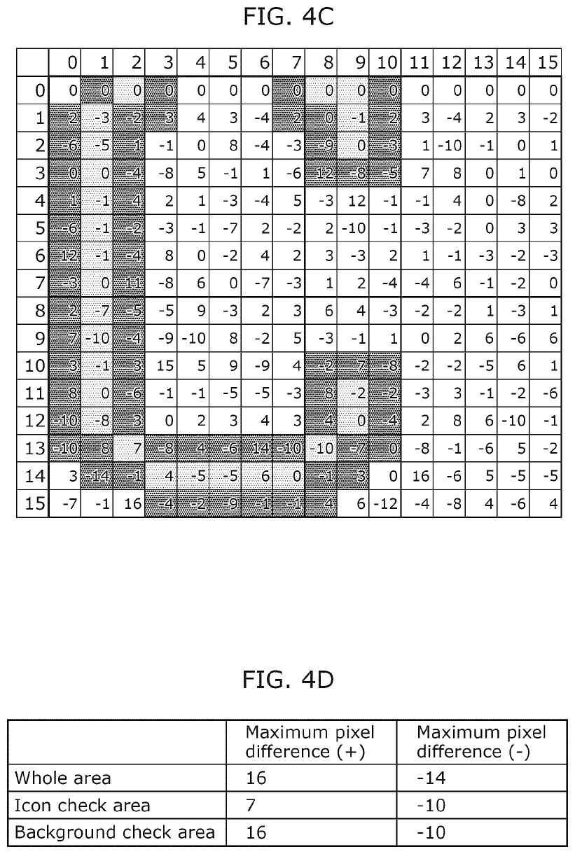

FIG. 4A is a conceptual diagram illustrating one example of a correct-answer icon image before image processing is performed on a character information image, according to the reference example and the embodiment to be described later.

FIG. 4B is a conceptual diagram illustrating, as an example of image processing, mosquito noise generated due to quantization errors when image compression is performed on the correct-answer icon image illustrated in FIG. 4A, according to the reference example and the embodiment to be described later. In an encoding process for image compression and a decoding process for image decompression, frequency conversion, quantization, inverse quantization, and inverse frequency conversion are performed. Specifically, frequency conversion and quantization are performed in an image encoding process, and inverse quantization and inverse frequency conversion are performed in an image decoding process. Here, an example in which frequency conversion, quantization, inverse quantization, and inverse frequency conversion are performed on a 16×16 pixel block in an image is shown.

In an image block after image compression and image decompression, mosquito noise may be generated due to quantization errors and image quality degradation may occur. Mosquito noise is likely to be visually recognized particularly in flat areas around the edges of the image block.

FIG. 4C illustrates, for a 16×16 pixel block in an image, information indicating differences between the current-answer icon image before image processing which is illustrated in FIG. 4A, and the image after image processing which is illustrated in FIG. 4B, according to the reference example and the embodiment to be described later. As can be seen from the numerical values shown in FIG. 4C, there is a tendency that due to image processing, mosquito noise is generated and image quality degradation occurs, resulting in an increase in the difference between the image in FIG. 4A and the image in FIG. 4B, as described above. Particularly, the area of the background part in an icon image is large and mosquito noise is likely to occur in the background part.

FIG. 4D is a diagram illustrating maximum values indicating a positive difference and a negative difference (a maximum pixel difference (+) and a maximum pixel difference (−)) in each of the entirety (the whole area), the icon area, and the background area in the 16×16 pixel block in FIG. 4C, according to the reference example and the embodiment to be described later. As can be seen from FIG. 4D, when image processing is performed in advance on a current icon image to be processed, it is a case where failure diagnosis is performed on the current icon image using, as a reference, a correct-answer icon image different from an assumed correct-answer icon image in FIG. 4A, and an unexpected false failure determination may occur.

As described above, in-vehicle telltale failure diagnosis device 140 according to the reference example determines that an icon image is a failure based on a correlation value obtained by independent calculation performed for the icon and the background part in the icon image. Accordingly, even when image quality degradation and a hue change occur in the current icon image due to image processing, by adjusting determination criteria for reducing an influence caused by noise, it is possible to inhibit, to a certain extent, false failure determination of determining that the icon image is not an assumed correct-answer icon image. However, it cannot be said that such false failure determination may be inhibited sufficiently.

In view of this, the following describes an embodiment of an in-vehicle telltale failure diagnosis device capable of surely inhibiting false failure determination that an icon image serving as a telltale is a failure, even when image quality degradation and a hue change occur in a current icon image to be processed due to image processing.

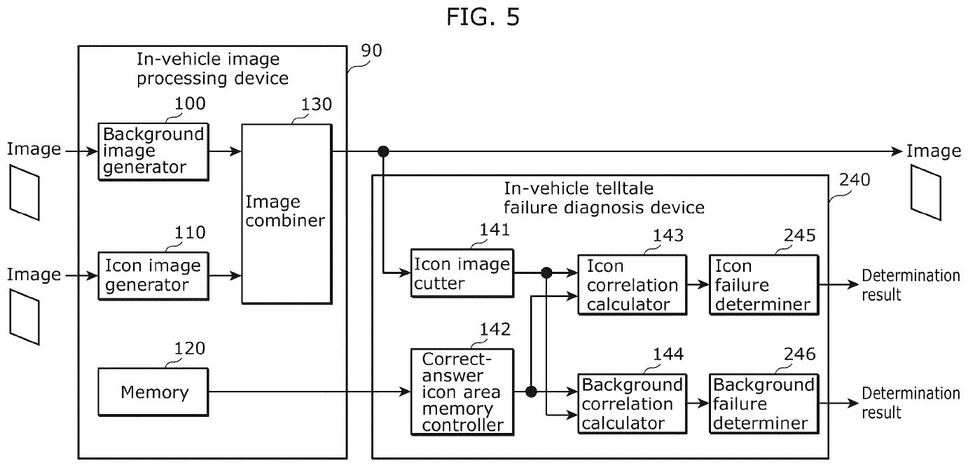

FIG. 5 is a block diagram illustrating the configuration of in-vehicle telltale failure diagnosis device 240 according to the embodiment. In-vehicle image processing device 90 that generates a combined image including an icon image on which failure diagnosis is to be performed by in-vehicle telltale failure diagnosis device 240 is also illustrated in the figure. In-vehicle telltale failure diagnosis device 240 illustrated in FIG. 5 also includes icon failure determiner 245 and background failure determiner 246 in addition to the elements included in in-vehicle telltale failure diagnosis device 140 according to the reference example. Hereinafter, same reference signs are assigned to the same elements as those included in in-vehicle telltale failure diagnosis device 140 according to the reference example, and description is omitted or simplified. The following focuses on differences from in-vehicle telltale failure diagnosis device 140 according to the reference example.

It should be noted that in the present embodiment, the correct-answer image of the background part in an icon image is composed of a set of pixels indicating a predetermined tonal color having the same hue and different brightnesses or chromas. Such a correct-answer image of the background part is read out from memory 120 by correct-answer icon area memory controller 142 or held by correct-answer icon area memory controller 142 in advance, and is used for the calculation of a second correlation value by background correlation calculator 144. In other words, in a determination performed by background correlation calculator 144, the second correlation value between the background part of the current icon image and a predetermined tonal color is calculated.

Icon failure determiner 245 determines whether the first correlation value calculated per pixel by icon correlation calculator 143 is within a first threshold value and correlation is low (i.e., the matching degree between the icon of the icon image and the icon of the correct-answer icon image is low), and also determines whether the number of pixels for which the first correlation value is determined to be within the first threshold value is a first predetermined number or greater. When determining that the number of pixels for which the first correlation value is determined to be within the first threshold value is the first predetermined number or greater, icon failure determiner 245 makes a provisional NG determination that the icon image is possibly a failure. The first predetermined value is, for example, a value obtained by multiplying the number of pixels in an icon area with a fixed percentage. The first threshold value is a variable value.

When a combined image is a moving image, icon failure determiner 245 determines, for each frame included in the combined image, whether the number of pixels for which the first correlation value is determined to be within the first threshold value and the correlation is low is the first predetermined number or greater. When making a provisional NG determination that frames in which the number of the pixels is the first predetermined number or greater occur consecutively for a first predetermined number of frames, icon failure determiner 245 determines, as a final result, that the icon image is a failure. The first predetermined number of frames is a variable value.

Background failure determiner 246 determines whether the second correlation value calculated per pixel by background correlation calculator 144 is within a second threshold value and correlation is low (i.e., the matching degree between the background part of the icon image and the background part of the correct-answer icon image is low), and also determines whether the number of pixels for which the second correlation value is determined to be within the second threshold value is a second predetermined number or greater. When determining that the number of pixels for which the second correlation value is determined to be within the second threshold value is the second predetermined number or greater, background failure determiner 246 makes a provisional NG determination that the icon image is possibly a failure. The second predetermined value is, for example, a value obtained by multiplying the number of pixels in a background area with a fixed percentage. The second threshold value is a variable value.

When a combined image is a moving image, background failure determiner 246 determines, for each frame included in the combined image, whether the number of pixels for which the second correlation value is determined to be within the second threshold value and the correlation is low is the second predetermined number or greater. When making a provisional NG determination that frames in which the number of the pixels is the second predetermined number or greater occur consecutively for a second predetermined number of frames, background failure determiner 246 determines, as a final result, that the icon image is a failure. The second predetermined number of frames is a variable value.

Thus, when a provisional NG determination is made for a frame based on the first correlation value calculated by icon correlation calculator 143 (i.e., a determination that the number of pixels for which the first correlation value is determined to be within the first threshold value in the frame is the first predetermined number or greater is made), icon failure determiner 245 counts the number of frames for which such a provisional NG determination is made consecutively. When the number of the frames exceeds a threshold value set for the number of times a provisional NG determination is made for a frame (i.e., a first predetermined number of frames), icon failure determiner 245 sends, as a final result, a determination result that an icon image (strictly speaking, the icon of the icon image) is a failure.

When a provisional NG determination is made for a frame based on the second correlation value calculated by background correlation calculator 144 (i.e., a determination that the number of pixels for which the second correlation value is determined to be within the second threshold value in the frame is the second predetermined number or greater is made), background failure determiner 246 counts the number of frames for which such a provisional NG determination is made consecutively. When the number of the frames exceeds a threshold value set for the number of times a provisional NG determination is made for a frame (i.e., a second predetermined number of frames), background failure determiner 246 sends, as a final result, a determination result that an icon image (strictly speaking, the background part of the icon image) is a failure.

With this, whether the current icon image is correct is determined in accordance with the correct-answer icon image.

It should be noted that, to be more specific, icon failure determiner 245 and background failure determiner 246 are implemented by, for instance, semiconductor logic circuits or a processor that performs processing in accordance with a program.

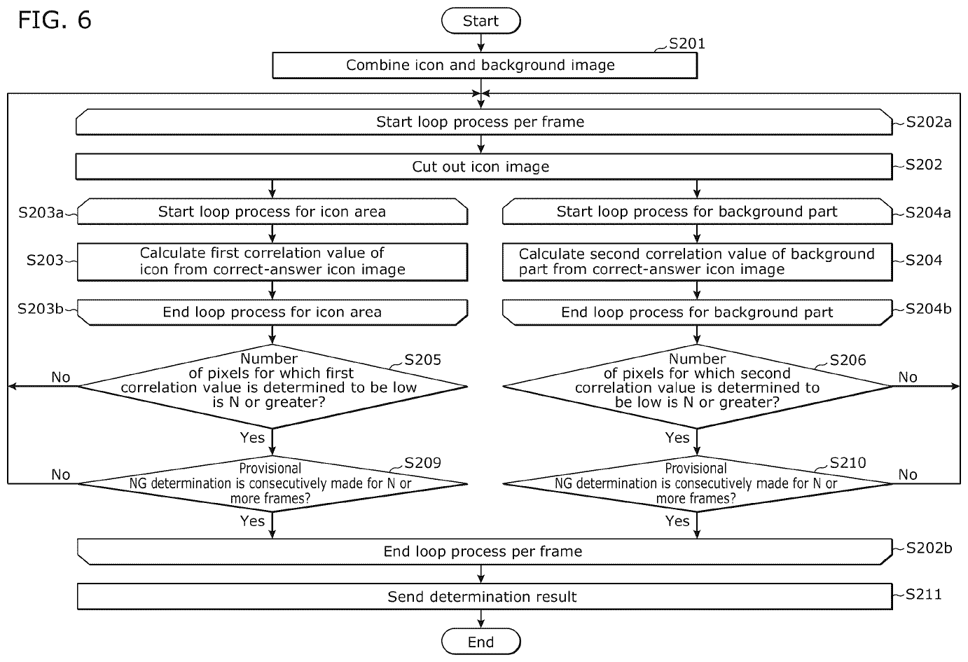

FIG. 6 is a flowchart illustrating the operation of in-vehicle telltale failure diagnosis device 240 illustrated in FIG. 5. First, an icon image and a background image are combined by image combiner 130 in in-vehicle image processing device 90 (S201). It should be noted that this combining process (S201) may be or may not be performed to generate an input image to be input to in-vehicle telltale failure diagnosis device 240. After that, a loop process per frame (S202a to S202b) is started, and in in-vehicle telltale failure diagnosis device 240, first, icon image cutter 141 cuts out an icon image per any current block having 64×64 pixels from a combined image output from image combiner 130 (S202).

Subsequently, a loop process (S203a and S203b) for each pixel in an icon area is started, and icon correlation calculator 143 repeats, for each component in the pixel, the calculation of the first correlation value between the icon included in data of the component in the current block (i.e., the current icon image) and the icon in the correct-answer icon image, based on information related to the icon area in the cut-out icon image and information related to the icon area in the correct-answer icon image notified from correct-answer icon area memory controller 142 (S203).

Also, a loop process (S204a and S204b) for each pixel in a background area is started, and background correlation calculator 144 repeats, for each component in the pixel, the calculation of the second correlation value between the background part included in data of the component in the current block (i.e., the current icon image) and the background part in the correct-answer icon image, based on information related to the background area in the cut-out icon image and information related to the background area in the correct-answer icon image notified from correct-answer icon area memory controller 142 (S204).

When determining, for each component, that there is no difference, among N or more pixels, between the icon in the correct-answer icon image which corresponds to the component in the current block and the icon in the current icon image (i.e., the number of pixels for which the first correlation value is determined to be within the first threshold value in the frame is not the first predetermined number or greater), based on the first correlation value calculated by icon correlation calculator 143 (No in S205), icon failure determiner 245 determines that the current icon image is not a failure and ends the process performed on the current block.

When a provisional NG determination that there is a difference, among N or more pixels, between the icon of the correct-answer icon image and the icon of the current icon image (i.e., the number of pixels for which the first correlation value is determined to be within the first threshold value in the frame is the first predetermined number or greater) (Yes in S205), and such a provisional NG determination is consecutively made for N or more frames (i.e., frames for which the provisional NG determination is made occur consecutively for the first predetermined number of frames) (Yes in S209), icon failure determiner 245 determines that the current icon image is a failure and sends an NG determination result as a final result (S211). When such a provisional NG determination is not made consecutively for N or more frames (No in S209), icon failure determiner 245 determines, as a final result, that the current icon image is not a failure, and continues checking on the icon image in the next frame (S202a and S202b).

Also, when determining, for each component and based on the second correlation value calculated by background correlation calculator 144, that there is no difference, among N or more pixels, between the background part in the correct-answer icon image which corresponds to the component in the current block and the background part of the current icon image (i.e., the number of pixels for which the second correlation value is determined to be within the second threshold value in the frame is not the second predetermined number or greater) (No in S206), background failure determiner 246 determines that the current icon image is not a failure and ends the process performed on the current block.

When a provisional NG determination that there is a difference, among N or more pixels, between the background part of the correct-answer icon image and the background part of the current icon image (i.e., the number of pixels for which the second correlation value is determined to be within the second threshold value in the frame is the second predetermined number or greater) is made (Yes in S206), and such a provisional NG determination is consecutively made for N or more frames (i.e., frames for which the provisional NG determination is made occur consecutively for the second predetermined number of frames) (Yes in S210), background failure determiner 246 determines that the current icon image is a failure and sends an NG determination result as a final result (S211). When such a provisional NG determination is not made consecutively for N or more frames (No in S210), background failure determiner 246 determines that the current icon image is not a failure, and continues checking on the icon image in the next frame (S202a and S202b).

Thus, with in-vehicle telltale failure diagnosis device 240 according to the present embodiment, when a first calculation value between the icon in a current icon image to be processed and the icon in a correct-answer icon image and a second calculation value between the background part in the current icon image and the background part in the correct-answer icon image are calculated per frame, and a provisional NG determination that the number of pixels for which the first correlation value is determined to be within the first threshold value is the first predetermined number or greater and a provisional NG determination that the number of pixels for which the second correlation value is determined to be within the second threshold value is the second predetermined number or greater are made, whether the provisional NG determination is consecutively made for the first predetermined number of frames and whether the provisional NG determination is consecutively made for the second predetermined number of frames are further determined. When the provisional NG determination is made consecutively for the first predetermined number of frames and the provisional NG determination is made consecutively for the second predetermined number of frames, it is determined that the icon image is a failure.

Accordingly, even when image quality degradation and a hue change occur in a current icon image to be processed due to image processing such as compression and decompression, an influence caused by random noise such as mosquito noise is removed by two-stage filtering that allows noise and includes threshold-based determination using correlation values and threshold-based determination using the number of consecutive frames, so that failure determination of determining that an icon image is a failure is accurately performed.

It should be noted that icon failure determiner 245 can change a first threshold value, a first predetermined number, and a first predetermined number of frames which are used in failure determination. When a current icon image to be processed is subjected to an encoding process for compression or a decoding process for decompression, for example, icon failure determiner 245 may obtain compression rate information from, for instance, a decoding processor, predict that the amount of noise increases as the obtained compression rate increases, and make adjustment to increase at least one of the first threshold value, the first predetermined number, or the first predetermined number of frames.

Likewise, background failure determiner 246 can change a second threshold value, a second predetermined number, and a second predetermined number of frames which are used in failure determination. When a current icon image to be processed is subjected to an encoding process for compression or a decoding process for decompression, for example, background failure determiner 246 may obtain compression rate information from, for instance, a decoding processor, predict that the amount of noise increases as the obtained compression rate increases, and make adjustment to increase at least one of the second threshold value, the second predetermined number, or the second predetermined number of frames.

Although aspects of the in-vehicle telltale failure diagnosis device according to the present disclosure have been described in accordance with the reference example and the embodiment, the aspects of the in-vehicle telltale failure diagnosis device are not limited to the reference example and the embodiment. Modifications that the person skilled in the art may conceive may be made to the reference example and the embodiment, or elements in the reference example and the embodiment may be arbitrarily combined.

For example, in the above embodiment, the background part of a correct-answer icon image is composed of a set of pixels representing a predetermined tonal color, and a second correlation value between the background part of the correct-answer icon image and the background part of a current icon image to be processed is calculated on a pixel-by-pixel basis by background correlation calculator 144, but the calculation of the second correlation value is not limited to this example. For example, all of pixels in the background area in the background part of the correct-answer icon image may have the same single color, an average value in the background area may be calculated for each chroma component in the background part of the current icon image, and a second correlation value, which indicates a high correlation value when the single color of the correct-answer icon image and the background color of the current icon image represented by the average value are tonal colors, may be calculated. With this, failure diagnosis is performed on the current icon image based on whether the color of the background part of the current icon image and the color of the background part of the correct-answer icon image are tonal colors.

In the above embodiment, a provisional NG determination is made when there is a difference, among N or more pixels, between the background part of a correct-answer icon image and the background part of a current icon image to be processed (i.e., a first correlation value is within a first threshold value and the correlation between the background parts is low), but a provisional NG determination may be made when there is no difference, among N or more pixels, between the background part of the correct-answer icon image and the background part of the current icon image (i.e., the first correlation value is the first threshold value or greater and the correlation is high). With this, when a failure pattern of a background part (e.g., all of pixels are white) is known in advance, by setting, as the background part of the correct-answer icon image, the image of the failure pattern that is known in advance, it is possible to determine that the current icon image is a failure when correlation with such a failure pattern is high.

In the above embodiment, filtering in two stages that are threshold-based determination using correlation values and threshold-based determination using the number of consecutive frames is performed for the icon and the background part of a current icon image to be processed, but the filtering in the two stages is not necessarily needed. Only filtering in one stage (i.e., threshold-based determination using correlation values) may be used to perform failure determination as a final result. With this, even when an icon image is a still image, the determination method according to the above embodiment can be applied.

In the above embodiment, when a predetermined condition is not satisfied for at least one of the icon or the background part of the current icon image, it is determined that the icon image is a failure. However, the predetermined condition is not limited to such a determination condition. For example, it may be determined that the icon image is a failure only when a predetermined condition is not satisfied for both the icon and the background part of the current icon image.

Moreover, processes performed by a specific element in an embodiment may be performed by a different element instead of the specific element. The order of processes may be changed, and processes may be performed in parallel. Variations may be combined and applied.

Moreover, an in-vehicle telltale failure diagnosis method including steps to be performed by each element in the in-vehicle telltale failure diagnosis device may be performed by any device or system. For example, part or whole of the in-vehicle telltale failure diagnosis method may be executed by a computer including, for instance, a processor, memory, and an input/output circuit. In this case, the in-vehicle telltale failure diagnosis method may be performed by the computer executing a program for causing the computer to execute the in-vehicle telltale failure diagnosis method.

The program may be recorded on a non-transitory computer-readable recording medium such as a CD-ROM.

Each of the elements of the in-vehicle telltale failure diagnosis device may be configured by dedicated hardware, or general hardware that executes, for instance, the aforementioned program, or by the combination of such hardware. The general hardware may be configured by, for instance, memory on which a program is recorded, and a general processor that reads and executes the program from the memory. Here, the memory may be, for instance, semiconductor memory or a hard disk, and the general processor may be, for instance, CPU.

The dedicated hardware may be configured by, for instance, memory and a dedicated processor. For example, the dedicated processor may reference memory for recording data and execute the above-described in-vehicle telltale failure diagnosis method.

The elements of the in-vehicle telltale failure diagnosis device may be electric circuits. These electric circuits may configure a single electric circuit as a whole, or may be separate circuits. These electric circuits may correspond to dedicated hardware or general hardware that executes, for instance, the aforementioned program.

Although only some exemplary embodiments of the present disclosure have been described in detail above, those skilled in the art will readily appreciate that many modifications are possible in the exemplary embodiments without materially departing from the novel teachings and advantages of the present disclosure. Accordingly, all such modifications are intended to be included within the scope of the present disclosure.

### INDUSTRIAL APPLICABILITY

An in-vehicle telltale failure diagnosis device according to the present disclosure is useful for, for example, in-vehicle telltale failure diagnosis devices that diagnose that an icon image generated by an in-vehicle image processing device, which uses image processing such as compression and decompression, is a failure, and is applicable to, for instance, image processing systems for automotive applications.

1. An in-vehicle telltale failure diagnosis device that diagnoses that an icon image generated by an in-vehicle image processing device is a failure, the in-vehicle image processing device including: a background image generator that generates a background image; an icon image generator that generates an icon image serving as a telltale; and an image combiner that generates a combined image by combining the icon image generated and the background image generated, the in-vehicle telltale failure diagnosis device comprising:
a correct-answer icon area memory controller that obtains and stores a reference correct-answer icon image;
an icon image cutter that cuts out the icon image from the combined image output from the image combiner;
an icon correlation calculator that calculates a first correlation value between an icon in the icon image that has been cut out by the icon image cutter and an icon in the reference correct-answer icon image stored in the correct-answer icon area memory controller;
a background correlation calculator that calculates a second correlation value between a background part excepting the icon in the icon image that has been cut out and a predetermined tonal color; and
an icon failure determiner that determines, based on the first correlation value calculated by the icon correlation calculator, that the icon in the icon image that has been cut out is a failure, and a background failure determiner that determines, based on the second correlation value calculated by the background correlation calculator, that the background part in the icon image that has been cut out is a failure.

2. The in-vehicle telltale failure diagnosis device according to claim 1, wherein
the reference correct-answer icon image includes the following as area information: an icon area; a background area; and an anti-aliasing area positioned at a boundary between the icon area and the background area,
the icon correlation calculator calculates the first correlation value of the icon area in the reference correct-answer icon image, and
the background correlation calculator calculates the second correlation value of the background area in the reference correct-answer icon image.

3. The in-vehicle telltale failure diagnosis device according to claim 1, wherein
the icon failure determiner (i) determines whether the first correlation value calculated on a pixel-by-pixel basis by the icon correlation calculator is within a first threshold value and correlation is low, (ii) further determines whether a total number of pixels for which the first correlation value is determined to be within the first threshold value is a first predetermined number or greater, and (iii) determines that the icon image is possibly a failure when determining that the total number of the pixels is the first predetermined number or greater.

4. The in-vehicle telltale failure diagnosis device according to claim 3, wherein
the first threshold value is a variable value.

5. The in-vehicle telltale failure diagnosis device according to claim 1, wherein
the background failure determiner (i) determines whether the second correlation value calculated on a pixel-by-pixel basis by the background correlation calculator is within a second threshold value and correlation is low, (ii) further determines whether a total number of pixels for which the second correlation value is determined to be within the second threshold value is a second predetermined number or greater, and (iii) determines that the icon image is possibly a failure when determining that the total number of the pixels is the second predetermined number or greater.

6. The in-vehicle telltale failure diagnosis device according to claim 5, wherein
the second threshold value is a variable value.

7. The in-vehicle telltale failure diagnosis device according to claim 3, wherein
the combined image is a moving image, and
the icon failure determiner (i) determines, for each frame included in the combined image, whether a total number of pixels for which the first correlation value is determined to be within the first threshold value is the first predetermined number or greater, and (ii) determines that the icon image is a failure when frames in which the total number of the pixels is the first predetermined number or greater occur consecutively for a first predetermined number of frames.

8. The in-vehicle telltale failure diagnosis device according to claim 7, wherein
the first predetermined number of frames is a variable value.

9. The in-vehicle telltale failure diagnosis device according to claim 5, wherein
the combined image is a moving image, and
the background failure determiner (i) determines, for each frame included in the combined image, whether a total number of pixels for which the second correlation value is determined to be within the second threshold value is the second predetermined number or greater, and (ii) determines that the icon image is a failure when frames in which the total number of the pixels is the second predetermined number or greater occur consecutively for a second predetermined number of frames.

10. The in-vehicle telltale failure diagnosis device according to claim 9, wherein
the second predetermined number of frames is a variable value.

11. An in-vehicle telltale failure diagnosis method of diagnosing that an icon image generated by an in-vehicle image processing device is a failure, the in-vehicle image processing device including: a background image generator that generates a background image; an icon image generator that generates an icon image serving as a telltale; and an image combiner that generates a combined image by combining the icon image generated and the background image generated, the in-vehicle telltale failure diagnosis method comprising:
obtaining and storing a reference correct-answer icon image;
cutting out the icon image from the combined image output from the image combiner;
calculating a first correlation value between an icon in the icon image that has been cut out in the cutting out of the icon image and an icon in the reference correct-answer icon image stored in the obtaining and storing of the reference correct-answer icon image;
calculating a second correlation value between a background part excepting the icon in the icon image that has been cut out and a predetermined tonal color; and
determining, based on the first correlation value calculated in the calculating of the first correlation value, that the icon in the icon image that has been cut out is a failure, and determining, based on the second correlation value calculated in the calculating of the second correlation value, that the background part in the icon image that has been cut out is a failure.
